(19) United States
(12) Patent Application Publication
(10) Pub. No.: US 2005/0175192 A1
(43) Pub. Date: Aug. 11, 2005

(54) Noise cancellation

(76) Inventor: David Ian Herman, Brighton (GB)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/471,470

(22) PCT Filed: Mar. 14, 2002
(86) PCT No.: PCT/GB02/01208

(30) Foreign Application Priority Data
Mar. 14, 2001 (GB) 0106269.4

(51) Int. Cl. H04B 15/00

(52) U.S. Cl. 381/94.7; 381/94.1

(57) ABSTRACT

A noise cancellation circuit has a first and second input for a first signal having a signal element and a noise element, and a second signal comprising at least a smaller amplitude of the said signal element, a first inverter arrangement for producing an inverted signal output that is an inverted form of one of the first and second signals, a first adder for adding the other signal and the inverted signal to produce an intermediate signal, an intermediate inverter arrangement for inverting the intermediate signal to produce an inverted intermediate signal, and a second adder for adding the other signal, the inverted signal and the inverted intermediate signal to produce an output.

The present invention relates to noise cancellation.

Noise cancellation in the audio or other frequency ranges is commonly based on the theory of using a first input of the desired signal plus noise, and a second input of noise alone. One input is phase inverted with respect to the other, and the two are then added so that the noise (common to both inputs) is cancelled, leaving the desired signal. The techniques used in practice are more sophisticated than this because the basic theory does not take into account other considerations. The input transducers (for example microphones in the audio frequency range) from which the input signals are derived also are non-ideal and, thus, impose distortions on the two inputs, but to different extents. Furthermore, the theory demands that the desired signal be absent from the second input or at least attenuated in it.

Previous techniques for improving on the basic approach to noise cancellation include filtering the output signal. However, filtering neglects to take into account the distortion imposed on the noise signal by the process of transducing it into a manageable electrical quantity, and subsequent signal processing.

Another technique is to digitise the analogue signals and apply digital signal processing to address the residual noise.

Other noise reduction methods that have been proposed involve the use of phased arrays of signal pick-ups (for example microphones). These are inflexible and expensive.

In spite of the fact that the basic technique of noise cancellation has been known for many decades, the incomplete noise cancellation due to distortions imposed on the two signals at the first and second inputs has only ever been addressed by such additional techniques of filtering, etc. which are unrelated to any comparison of the signals themselves. The limit on the extent to which noise cancellation can be effective resides, at least in part, in the distortion of the transduced signals. For example, microphones used in pairs or other groupings are not identical and do not produce exactly the same signals for a given input. A matched pair of microphones can be used to minimise this problem, but they will never be identical and, in any event, will cost more. Another problem is the spacing of the transducers in relation to the source. Microphones will be located at different positions and, therefore, will be exposed to slightly different noise stimulation.

According to the present invention there is provided a noise cancellation circuit comprising: a first input for a first signal having a signal element and a noise element; a second input for a second signal comprising at least a smaller amplitude of the said signal element; a first inverter arrangement for producing an inverted signal output that is an inverted form of one of the first and second signals; a first adder for adding the other signal and the inverted signal to produce an intermediate signal; an intermediate inverter arrangement for inverting the intermediate signal to produce an inverted intermediate signal; and a second adder for adding the other signal, the inverted signal and the inverted intermediate signal to produce an output.

Also, according to the present invention there is provided a method of noise cancellation comprising comparing a first signal having a signal element and a noise element, with a second signal having at least a smaller amplitude of the said signal element to produce an intermediate signal, and subtracting the intermediate signal from a comparison of the first signal and the second signal to produce an output.

The present invention provides a particularly beneficial effect that is not intuitive. This is because the circuit of the invention compares the noise in signals received, as transduced at the second input, with itself further to reduce the noise which is reduced in any event by comparing the noise at the first and second inputs separately. The effect is to cancel noise by comparing similar responses and, thereby, avoid the effects of distortions due to which the cancellation previously effected according to known principles was less effective. By comparing the first input, the second input and the intermediate signal, the distorting effect at the circuit input is also taken into account. The noise cancelling effect can be optimised for a given application according to the relative attenuations/amplifications of the signals at the second adder.

Preferably, transducers are connected to the first and second inputs by which signals are received and to which the noise cancelling process is to be applied.

In a particular form of the invention the first inverter arrangement is arranged to invert the second signal from the second input to produce the inverted signal.

The invention is particularly applicable to the audio frequency range, but is not limited to it. The invention applies to any frequency range and applications where the effects of distortion caused by the input should be taken into account.

Preferably, the second input can be derived by using transducers in which the transducer connected with the first input is constructed and/or arranged to reduce the reception of the signal element by the second transducer. For example, when the transducers are microphones, one microphone connected with the second input can be arranged to be baffled in its reception of the signal element, by the presence of the microphone connected with the first input in the direction of reception of the signal elements or by an additional baffle. In the case of microphones, it is found that the receiving faces are preferably spaced by a distance in the range of 0.2 mm to 2.5 mm, preferably 0.625 mm. Alternatively, the baffle can be introduced to attenuate the signal reaching the noise microphone. The attenuation of the signal element received by the second (noise) microphone is due to the baffling effect of the microphone in front, and also the distance of the second microphone from the signal source. Thus, it is preferable that the microphones are directional.

The subtraction and inversion of signals is preferably carried out using operational amplifiers in the analogue domain. However, other analogue circuit techniques could be used to equal effect, such as transistor amplifiers.

In a preferred embodiment of the invention the first and second signals are each low pass filtered. This signal conditioning is used to smooth out the characteristic spikes of high frequency noise in the signal. As a result, the signals to be cancelled present a broader (less acute) target of a lower power spectral density. The cancellation technique is more effective when applied to the low pass filtered signals because the circuit is less sensitive to phase distortion and timeshifts of either or both of the input signals.

The invention is equally applicable to the digital domain in which some unwanted distortion noise is added at the analogue-to-digital conversion stage when analogue signals are converted into digital data. The same issues of signal processing distortion can be addressed by comparing the originally digitised signal plus ambient noise, an inverted form of the originally digitised signal with a small amplitude signal element and an inverted form of the intermediate digital signal.

The invention can be put into practice in various ways, some of which will now by described by way of example with reference to the accompanying drawings, in which:

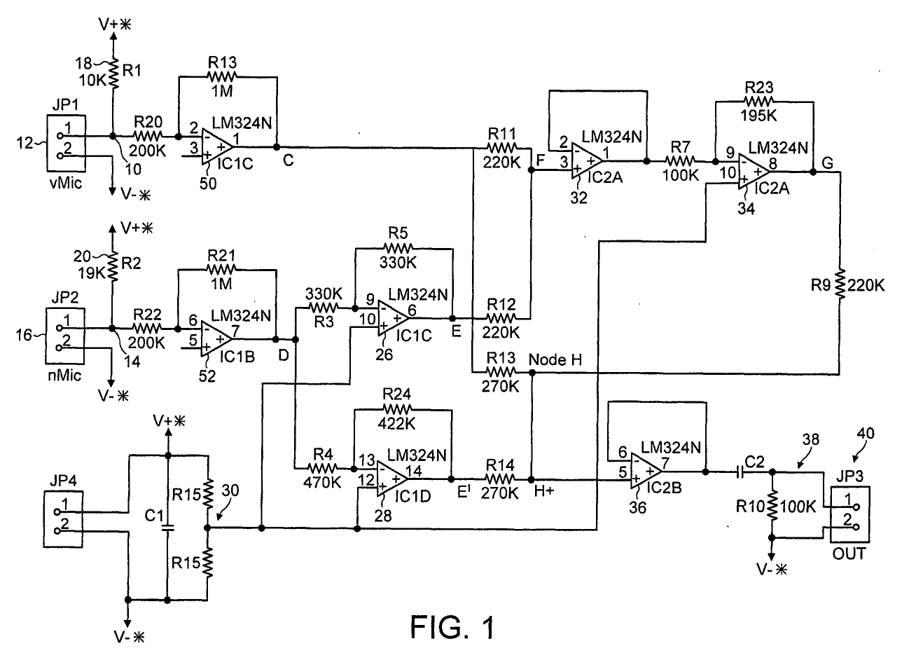

FIG. 1 is a circuit diagram of one embodiment of the present invention;

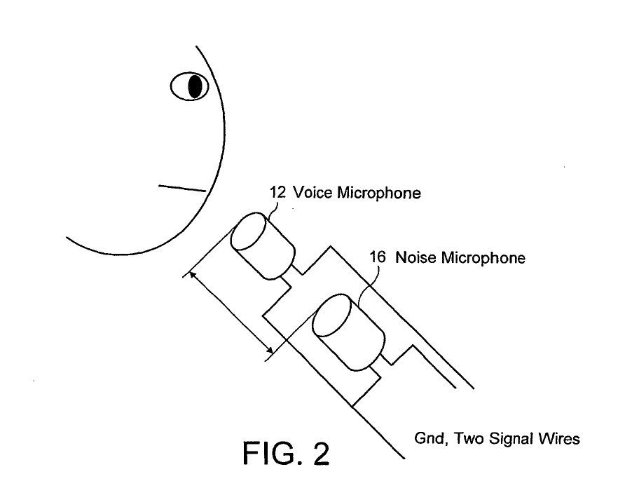

FIG. 2 is an illustration of the orientation of audio microphones for use in the present invention;

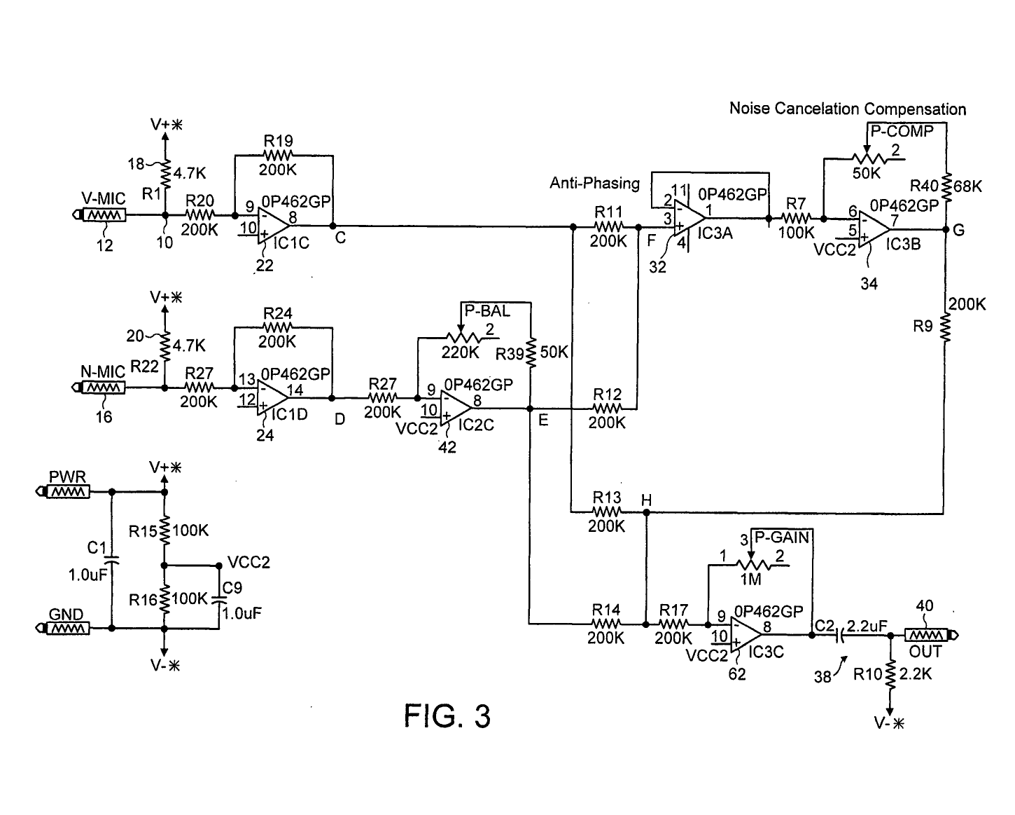

FIG. 3 is a circuit diagram of an alternative form of the circuit of FIG. 1;

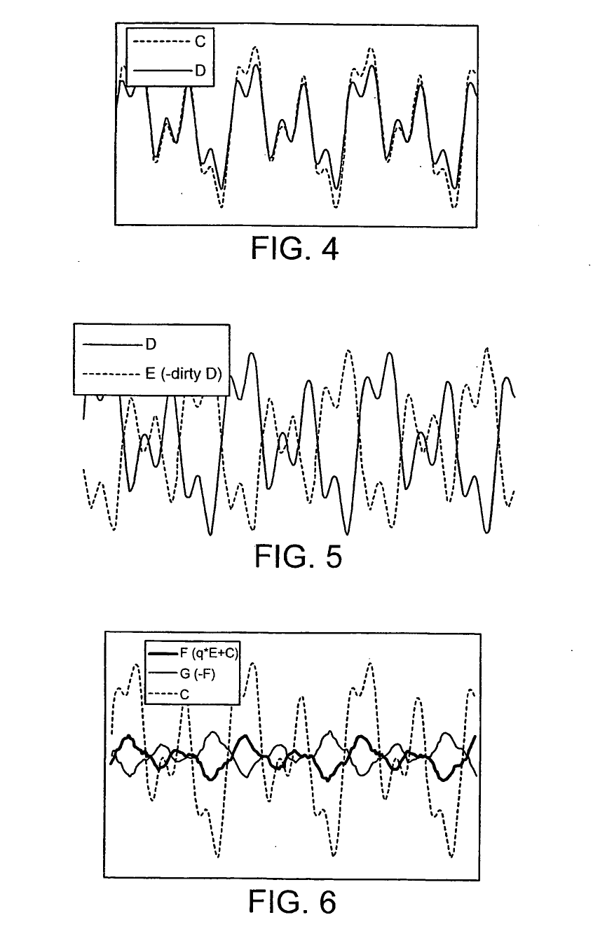

FIGS. 4 to 7 are graphic illustrations of signals in the circuit of FIG. 1;

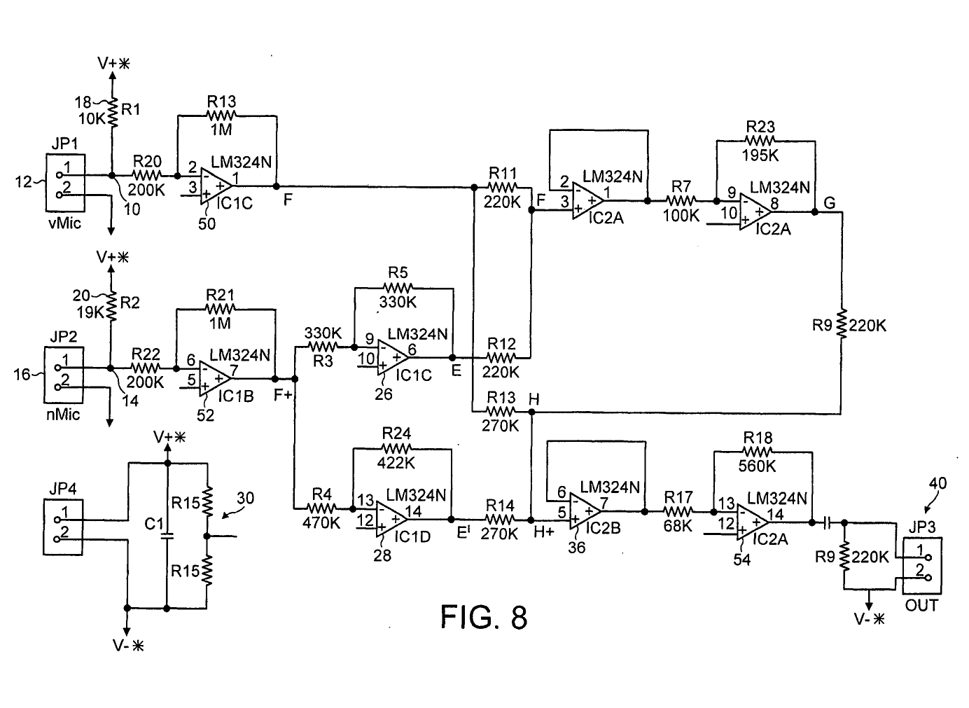

FIG. 8 is a circuit according to an alternative embodiment:

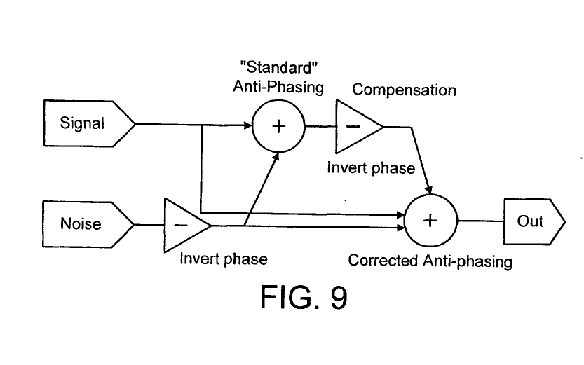

FIG. 9 is a generalised block diagram according to the invention; and

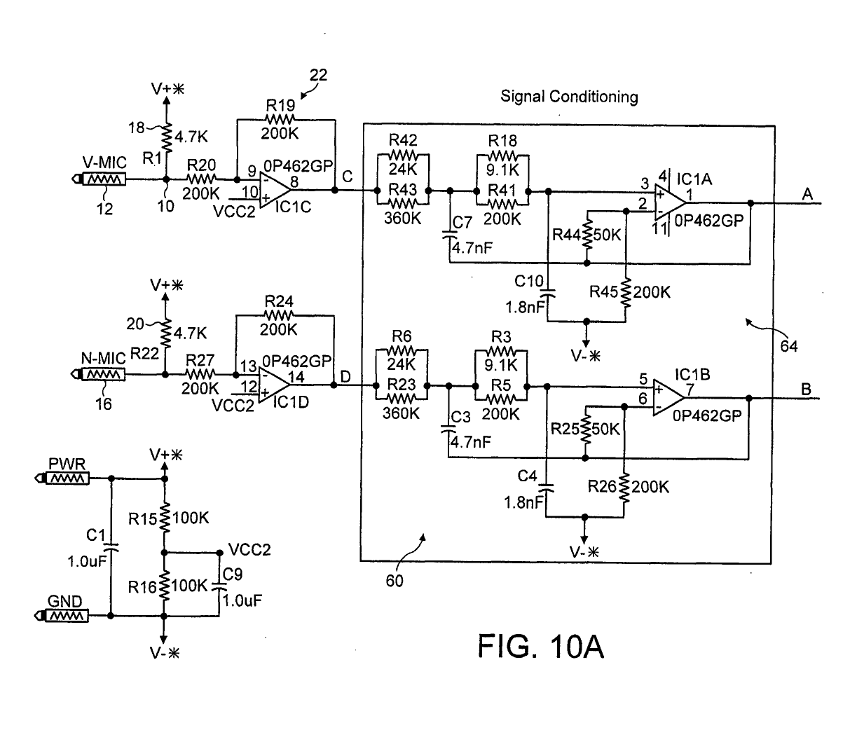

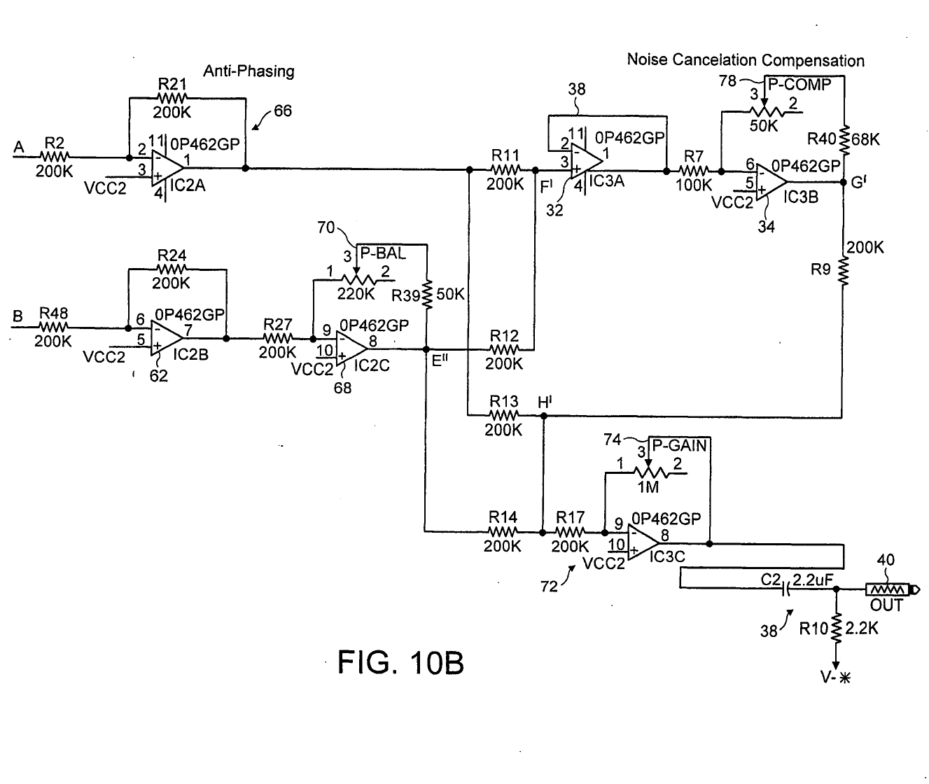

FIG. 10 is a circuit according to a further alternative embodiment.

Referring to FIG. 1, a noise cancellation circuit for audio frequencies comprises a first input 10 for an electret voice microphone 12. The microphone is a transducer, converting acoustic signals into analogue electrical signals. The acoustic signals are accompanied by ambient noise within the dynamic range of the microphone. It is the noise that must be cancelled as much as possible to derive a more faithful signal at the output of the circuit. A second input 14 has an electret noise microphone 16 connected to it. Both first and second inputs 10 and 14 are connected between a negative voltage rail (−) and respective 5 kohm pull-up resistors 18/20 connected to a positive voltage rail (+) in each case. Other forms of microphone could be used, such as dynamic (electromagnetic), crystal or carbon, that do not require any power connections. Directional microphones are desirable in order to provide at least some selectivity in picking up the signal.

The signal level for each input 10/14 is buffered by a unity gain non-inverting operational amplifier 22/24. The outputs of the buffer amplifiers 22/24 for the voice/noise microphones 12/14 are labelled as points C and D, respectively, in FIG. 1. The non-inverted signal at point D from the noise microphone 16 is connected to the inverting inputs of a pair of inverting operational amplifiers 26/28 which are also connected to a mid-supply voltage reference level 30 by their respective non-inverting inputs, to centre their output with respect to the full supply voltage swing, The operational amplifier 26 is arranged as an inverting attenuator with a gain of 0.85, providing a signal at point E of the inverted attenuated form of the signal at point D. The operational amplifier 28 is arranged as an inverting attenuator with a gain of 0.72 at point E′ of the signal at point D. Other settings (for example unity gain) for the attenuation of the signals will depend on, for example, the microphones and other circuit components used and the supply potential. The gains of the op-amps 26 and 28 are preferably the same or close enough to provide signals of similar amplitude in order not to impose undue burdens on the rest of the circuit or undermine the noise cancelling functionality.

The signals at points C and E are combined at point F through resistors R11 and R12 so that the voice signal at C is, in effect, added to the inverted attenuated form of the noise signal at E. The effect of the addition of these two signals at point F should, in theory, realise the cancellation of the common, but antiphase, signals in each (i.e. the noise) subject to what attenuation of the signal at D is caused by the attenuator 26. However, it is well known that this is not the case in practice. This is because the signals received at the microphones 12 and 16 are subject to different distortions due, for example, to the non-linearities in the system, and thermal and temporal component drift. Thus, it is not the case that the noise in one line can simply be a faithful but inverted form of the other. While, in the past, the thinking has been to approach the residual noise problem by filtering and other more sophisticated techniques, the invention makes use of the result of this comparison to reduce the noise by reapplying it to the circuit.

The reduced noise at point F is buffered by a further unity gain non-inverting amplifier 32 and amplified by a compensating inverting amplifier 34 with a gain of 1.95. The output of the amplifier 32 is an intermediate signal consisting of an inverted form of the signal at point C which is indicated in FIG. 1 as point G. The signal at G is attenuated relative to the signal at the point E.

At point H in the circuit, the signal from the second inverting attenuator 28 at point E′ is added to the signal at point C and the intermediate signal at point G through resistors R9, R13 and R14. The combined signal is buffered by a unity gain non-inverting amplifier 36, filtered by an a.c. couple 38 to remove any dc component, and connected to an output 40.

FIG. 2 illustrates the arrangement of the microphones 12 and 16 also according to the present invention. While each microphone can pick up sound from more than one direction, it has a predominant direction of reception and is, to that extent, directional. It will be seen in FIG. 2 that the noise microphone 16 is arranged with its receiving face about 0.625 mm (¼″) behind the receiving face of the voice microphone. In this way, the voice microphone is fully exposed to the desired input signal (i.e. speech), but also presents a baffle to the reception of the same desired signal by the noise microphone so that the desired signal is attenuated at the noise microphone. In this way, the noise microphone receives a relatively greater proportion of noise signal input than the voice microphone. The arrangement of the voice and noise microphones may differ according to application, type of microphones used, distance from the source of the desired signal, etc., and can be derived empirically according to circumstances.

FIG. 3 shows a modified form of the circuit in FIG. 1. An amplifier 42 with adjustable gain is used to perform the functions of the amplifiers 26 and 28. Thus, the signals at points E and E′, which are essentially the same are now rendered simply at the point E in FIG. 3, and connected to the resistors R12 and R14 in parallel. It is found that it is easier to balance the signal by using only a single amplifier at this point.

FIG. 4 illustrates the two transduced signals, as read at points C and D of the circuit of FIG. 1. They each comprise a wanted voice signal (in this case a basic sinusoid for the sake of illustration) and a distorting noise component superimposed upon the wanted signal. They are similar as both are exposed to the same noise sources, but the voice signal at point D is slightly attenuated by about 0.15 relative to that at point C due, at least in part, to the baffling effect of the voice microphone 12 in front of the noise microphone 16, and/or their relative distances from the source of the sound, as shown in FIG. 2.

FIG. 5 shows a comparison of the waveforms at points D and E, which latter waveform is the attenuated inverted form of the waveform at point D. It is also equivalent to the waveform at point E′ as well. The waveform at point E can be considered as a negative ‘dirty’ form of that at D because a small random variation has been introduced into the signal, associated with small physical and electrical differences between the two microphones 12/16 due, for example, to manufacturing tolerances in the circuit components.

FIG. 6 illustrates the signals at point C, F and G. The signal at point F is the reduced amplitude, reduced noise signal due to the addition of the antiphase signals at points C and E, but it still contains significant noise products due to the dissimilarity in the transduced noise signal components caused by the differently distorting effects of the two microphones. The signal at point G is the inverted and attenuated form of the signal at point F which is itself used in the circuit. The signal at point C is shown for comparison with the signal at point F to illustrate that there is noise reduction albeit with an attenuated voice signal as well. This is an illustration of the point in the circuit at which the prior art would apply filtering and other techniques to address the remaining noise.

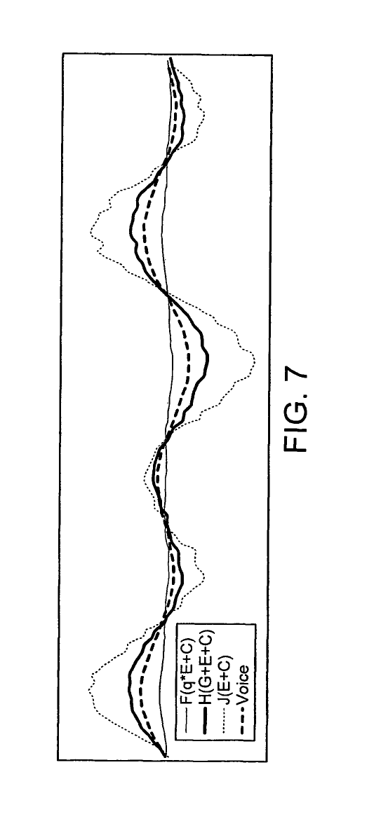

FIG. 7 shows the signal at point C compared with the signal at point F (as in FIG. 6) and also as compared with the signal at point H after the signals at point C and E′ have been added to the inverted form of the signal at point F (i.e. the signal at point G). As a result of applying the invention, the signal at point H is seen to contain far less noise than at point F for a similar output voice signal amplitude. The invention addresses the additional distortion in the signal due to the transducers. The invention provides a technique that does this by adding the signal at G, which is the noise-reduced inverted and attenuated signal at F from the basic difference between the output of the noise microphone at point D.

To arrive at balanced settings for the gains of the various op-amps in the circuit by which noise at the point H is cancelled to an improved extent, the resistor R8 on the op-amp 34 is made adjustable. By placing a microphone arrangement as shown in FIG. 2 so that its predominant reception direction is at right angles to a source of noise (so that both microphones receive equal noise input) the value of R8 is adjusted until the noise output at the op-amp 36 is minimised. It is also possible to adjust the values of the gains of the other op-amps in the circuit, such as those of the op-amps 26 and 28 for example, to the same end. However, R8 is the convenient resistance to choose as it limits the number of adjustments that have to be made.

The invention has been described in terms of audio frequencies. However, the invention is equally applicable to other frequency ranges and applications in which the distorting effect of transducing one signal into another form imposes different distortions on the signals to be compared for the purposes of noise reduction.

The invention provides improvements in signal to noise that are of benefit both objectively and subjectively. Objectively it is found that the signal to noise improvements have particular advantages in speech decoding schemes such as voice recognition software. Subjectively, the clarity of the reproduced sound is particularly useful in telephony and radio and other analogue/digital speech communication systems.

It will be appreciated from the description that the preferred embodiment uses very readily available components such as operational amplifiers, basic resistors and capacitors and transducers, and can be implemented on an integrated circuit very easily. The invention is particularly suited to incorporation into equipment at the manufacturing stage or as additional equipment for existing products, such as in wired and wireless telephony.

FIG. 8 illustrates an alternative embodiment of the invention in which like reference numerals have been used for like parts. In this circuit input op-amps 50 and 52 for the signal and noise channels, respectively, have gains. The output also has an op-amp amplifier 54 with non-unity gain. It is necessary to boost the output for certain applications. It is found that it is beneficial to do this at least partly by amplifying the inputs, and subjecting any amplification of the noise to the same noise cancelling by the circuit, and to limit the amplification at the output.

To summarise the operations of circuit, the desired signal plus noise at point C is combined both with the inverted form of the more noisy signal at point E′ and the inverted and attenuated form of the noise-cancelled signal at point G produced by comparing the signals at point C and D. This is illustrated in FIG. 9 in block diagram form. Because of distortions, the noise is not sufficiently cancelled for many applications at point G as there is not complete identity between the signals at points C and D. The addition of this signal in adjusted form with the inverted noise signal and the voice signal substantially reduces still further the noise at the output 40 according to the relative choice of amplification/attenuation factors of the signals at the various points.

FIG. 10 illustrates a further embodiment of the invention. In the drawing, parts corresponding to those in FIGS. 1 and 8 have been given like reference numerals. In this embodiment, the signal at the point D is applied to the input of a second order Chebyshev low pass filter 60 with a 4 kHz cut-off frequency. The output of the filter 60 is inverted by a unity gain inverter 62 to provide the equivalent of point E referred to previously. Similarly, the signal at point C is low pass filter by a second order Chebyshev filter 64 and inverted by a unity gain inverter 66.

The output of the inverter 62 is applied to the input of an adjustable amplifier 68, having a variable feedback resistor 70, providing an output at point E″ that is equivalent to point E in FIG. 3. According to the adjustment of the feedback resistors 70, the amplifier may be adjusted to act as an attenuator.

The signals from the respective microphones 12/16 are now in the form of smooth (high frequency attenuated), inverted and attenuated (in the case of the noise microphone signal) outputs. These are added at the point F′ (equivalent to the point F in FIGS. 1, 2 and 8) after resistors R11 and R12 to provide a high impedance input to the buffer amplifier 32. They are also added at the point H′ after resistors R13 and R14 to provide a high impedance input to a further adjustable amplifier 72 having a variable feedback resistor 74.

The added signals at point H′ are connected to the output of the inverter 76 at point G′ (equivalent to point G in FIGS. 1, 2 and 8). The added signals at point F′ are buffered by the buffer 32 and inverted by an adjustable gain inverter 76 (equivalent to the inverter 34 in FIGS. 1 and 8), having a variable resistor 78. Thus, the added signals at points F′ and H′ are combined at G′, which is attenuated relative to the signal at point E, as before.

According to this embodiment of the invention, the filtering and antiphasing is carried out on each signal substantially identically but electrically separate. The filtered and inverted signals are provided as high impedance inputs at resistors R11, R12, R13 and R14. One antiphase (inverted) combination of signals takes place at point F′ and the other separately at point H′. The antiphase combining at point F′ is used to determine a ‘compensation signal’ that is added to the other antiphase signal at point H′. The result is a optimally antiphase combination of signals at H′. The signal at H′ is the basic advantageously noise cancelled output. This is then buffered by buffer 72 and further low pass filtered in a second order Chebyshev filter 80. The output of the filter is further buffered by buffer 82 before being a.c. coupled at 40, as before, to provide the conditioned noise cancelled output.

To set up the circuit of FIG. 10 for a given situation, microphones and output, the following procedure is used.
1. Set the variable resistors 70 and 78 at zero.
2. Set the variable resistor 74 for full amplifier gain.
3. Connect an oscilloscope to the output 40 and arrange the noise and voice microphone so that their predominant direction of reception is orthogonal to the location of the noise.
4. Adjust the resistor 70 for minimum amplitude output on the oscilloscope.
5. Adjust the resistor 78 further to minimise the output on the oscilloscope.
6. Reorient the microphones towards the noise source.
7. Adjust the resistor 78 and 74 to achieve the desired output amplitude.

It will be appreciated by those of ordinary skill in the art that, as well as the digital implementation of the invention, it is also possible for other components to be used to the same effect for different parts of the circuits disclosed. For example, the filters in the circuits of FIGS. 1, 8 and 10 could be any suitable active or passive arrangement that provides the required cut-off frequency and attenuation rates. Examples include Butterworth, Elliptical and Bessel filters, and infinite and finite impulse response filters in the digital domain. The purpose of the filters 26, 28 or 60, 64 for the microphone inputs is to reduce the typically sharp spikes of noise components in a signal caused by high frequency noise in a given spectrum so that they are in a more smooth (high frequency attenuated) form. It is found that the attenuation of sharp unfiltered spikes of noise is less effective when there is less than perfect phase and amplitude comparison. This has the effect of reducing the sensitivity of the circuit to phase shifts introduced by circuit components and/or the microphones. This significantly improves the noise cancellation performance. Because the invention does not rely on precise matching of components, the increased tolerance derived from low pass filtering the signals is of particularly beneficial effect.

It will be apparent from the foregoing that the present invention can be realised in many different ways. The invention is not limited to those described herein, but only according to the spirit and scope of the following claims.

1. A noise cancellation circuit comprising:
a first input for a first signal having a signal element and a noise element;
a second input for a second signal comprising at least a smaller amplitude of the said signal element;
a first inverter arrangement for producing an inverted signal output that is an inverted form of one of the first and second signals;
a first adder for adding the other signal and the inverted signal to produce an intermediate signal;
an intermediate inverter arrangement for inverting the intermediate signal to produce an inverted intermediate signal; and
a second adder for adding the other signal, the inverted signal and the inverted intermediate signal to produce an output.

2. A circuit as claimed in claim 1 in which the first inverter arrangement comprises a first inverter having an output of a first inverted signal which is operably connected with the first adder, and a second inverter having an output of a second inverted signal which is operably connected with the second adder.

3. A circuit as claimed in claim 1, including means for balancing the amplitude of the noise in the first signal, the inverted signal and the inverted intermediate signal, such that it is substantially cancelled in the output.

4. A circuit as claimed in claim 3 in which the means for balancing include at least one variable gain amplifier.

5. A circuit as claimed in claim 4 in which the first inverter includes the variable gain amplifier.

6. A circuit as claimed in claim 4 in which the intermediate inverter includes the variable gain amplifier.

7. A circuit as claimed in claim 4, in which the output of the second adder is connected to the variable gain amplifier.

8. A circuit as claimed in claim 1 in which the intermediate inverter attenuates the intermediate signal.

9. A circuit as claimed in claim 1, including a first transducer operably connected with the first input, and a second transducer operably connected with the second input, the second transducer being constructed and/or arranged to receive at least an attenuated amplitude of the signal element relative to the signal element received by the first transducer.

10. A circuit as claimed in claim 9 in which at least one of the first and second transducers is] constructed and arranged to inhibit the reception of the signal element by the second transducer.

11. A circuit as claimed in claim 9 in which the transducers are microphones.

12. A circuit as claimed in claim 9 in which the transducers are microphones and in which the second microphone is arranged with a baffle to reception of the signal element.

13. A circuit as claimed in claim 12 in which the microphones are directional, the first microphone being arranged in front of the second microphone along the major direction of reception of signal thereby.

14. A circuit as claimed in claim 13 in which the receiving faces of the microphones are spaced by a distance in the range 0.2 mm to 2.5 mm, preferably 0.625 mm.

15. A circuit as claimed in claim 1 in which the first inverter arrangement is arranged to invert the second signal from the second input to produce the inverted signal.

16. A circuit as claimed in claim 1 in which the first and second signals are low pass filtered to attenuate higher frequency noise.

17. A method of noise reduction comprising:
comparing a first signal having a signal element and a noise element and a second signal having at least a smaller amplitude of the said signal element to produce an intermediate signal; and
subtracting the intermediate signal from a comparison of the first signal and the second signal to produce an output in which the noise is reduced.

18. A microphone arrangement for a noise cancellation circuit, comprising a first microphone arranged to receive a signal element and a noise element, a second microphone arranged with a baffle such that it receives at least a smaller amplitude of signal element relative to the first microphone.

19. A microphone arrangement as claimed in claim 18 in which the second microphone is arranged in relation to the first microphone such that the first microphone acts as a baffle to receipt of the signal element by the second microphone.

20. A circuit as claimed in claim 9 in which the transducers are microphones and in which the second microphone is arranged with a baffle to reception of the signal element and in which the second microphone is arranged at a greater distance from the signal source than the first microphone.

21. A circuit as claimed in claim 9 in which the transducers are microphones and in which the second microphone is arranged at a greater distance from the signal source than the first microphone.
